(19) United States
(12) Patent Application Publication
(10) Pub. No.: US 2007/0247403 A1
(43) Pub. Date: Oct. 25, 2007

(54) FLAT-PANEL DISPLAY DEVICE AND DISPLAY DRIVING METHOD

(76) Inventor: Yoshiki Ishizuka, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/768,945

(22) Filed: Jun. 27, 2007

Related U.S. Application Data
(63) Continuation of application No. PCT/JP05/23349, filed on Dec. 20, 2005.

(30) Foreign Application Priority Data
Dec. 27, 2004 (JP) 2004-376765

(51) Int. Cl. G09G 3/36

(52) U.S. Cl. 345/87

(57) ABSTRACT

A flat-panel display device includes a display panel having scanning lines, signal lines, and pixels which have electron-emitters each connected between one scanning line and one signal line, and a drive circuit which sequentially drives the scanning lines with a scanning signal and drives the signal lines with drive signals while each scanning line is being driven. The drive signals have pulse widths corresponding to levels of a video signal for one horizontal line and are of opposite voltage polarity to the scanning signal to set the pixel voltage for a pixel which should emit light to a value exceeding the threshold of the electron-emitters and to set the pixel voltage for a pixel which should emit light to a value less than the threshold of the electron-emitters. The drive circuit temporarily increases the pixel voltage of the pixel which should not emit light, upon driving of each scanning line.

### CROSS REFERENCE TO RELATED APPLICATIONS

This is a Continuation Application of PCT Application No. PCT/JP2005/023349, filed Dec. 20, 2005, which was published under PCT Article 21(2) in Japanese.

This application is based upon and claims the benefit of priority from prior Japanese Patent Application No. 2004-376765, filed Dec. 27, 2004, the entire contents of which are incorporated herein by reference.

### BACKGROUND OF THE INVENTION

1. Field of the Invention

The present invention relates to a flat-panel display device, such as a field emission display (FED), in which a plurality of pixels are formed using surface-conduction electron-emitters by way of example and a display driving method.

2. Description of the Related Art

The FED generally includes a display panel and a drive circuit which drives that display panel. The display panel includes a plurality of scanning lines extending in the lateral (horizontal) direction, a plurality of signal lines extending in the longitudinal (vertical) direction to intersect the scanning lines, and a plurality of pixels located at the intersections between the scanning lines and the signal lines (see, for example, JP-A No. 2002-221933 [KOKAI]). With a color display panel, for example, three pixels which adjoin in the horizontal direction realize a color pixel unit. Each pixel is formed of a surface-conduction electron-emitter and a phosphor of red (R), green (G), or blue (B) which is caused to emit light by an electron beam emitted from the corresponding electron-emitter.

The drive circuit includes a Y driver which is connected to one ends of the scanning lines and an X driver which is connected to one ends of the signal lines. The Y driver sequentially drives the scanning lines with a scanning signal. The X driver drives the signal lines with PWM drive signals having pulse widths corresponding to gradation levels of a video signal while each scanning line is being driven. Each pixel emits light in accordance with a pixel voltage between the corresponding signal and scanning lines, and the luminance thereof corresponds to an application period of the pixel voltage. Specifically, the scanning signal and the PWM drive signal set the potential Vy on the corresponding scanning line and the potential Vx on the corresponding signal line to Vy=−10.5V and Vx=+8V, thereby obtaining a pixel voltage of 18.5V between the scanning and signal lines to drive the electron-emitter. For pixels which should not emit light, the pulse widths of the PWM drive signals are set to zero to thereby keep the pixel voltage below the drive threshold of the electron-emitters.

By the way, in the display operation of the conventional FED, there arises a problem that the in-plane luminance characteristic of the display panel degrades nonuniformly. A detailed analysis confirmed that the problem is caused by, when the electron-emitter of a certain pixel discharges, the electron-emitters arranged along the same scanning line suffering damage. The method of analysis was as follows: The entire display panel was displayed in one color with blue pixels (B). After the discharge, the entire display panel was displayed in white with red (R), green (G), and blue (B) pixels to confirm damage from luminance measurement. By making a comparison of the luminance after the discharge with that before the discharge, the degradation in luminance due to the discharge was analyzed.

FIG. 5 shows a distribution of moving average values of the luminance ratio (luminance after discharge/luminance before discharge) obtained when the pixel in the plane coordinate position (315, 96) which is driven through the 315th signal line and the 96th scanning lines on the display panel is set as a point of discharge. Likewise, FIGS. 6, 7 and 8 show distributions of moving average values of the luminance ratio when the pixels in the plane coordinate positions (717, 182), (2997, 339) and (2787, 375) are each set as a point of discharge. Here, the points of discharge are all blue pixels. From FIGS. 5 through 8, it can be seen that the degree of spreading of damage differs according to the display color. The spreading of damage of the electron-emitter of the blue pixel which was driven at the time of discharge is small. The spreading of damage of the electron-emitters of the red and green pixels which were not driven at the time of discharge is large.

### BRIEF SUMMARY OF THE INVENTION

The object of the present invention is to provide a flat-panel display device and a display driving method which allows discharge damage which spreads along scanning lines to be reduced.

According to a first aspect of the present invention, there is provided a flat-panel display device which comprises a display panel having a plurality of scanning lines, a plurality of signal lines, and a plurality of pixels located near intersections between the scanning lines and the signal lines and having electron-emitters each of which is connected to a corresponding scanning line and a corresponding signal line; and a drive circuit which sequentially drives the scanning lines with a scanning signal and drives the signal lines by drive signals while each of the scanning lines is being driven, the drive signals having pulse widths corresponding to levels of a video signal for one horizontal line and being of opposite voltage polarity to the scanning signal, to set, as the sum of the scanning signal and the drive signal, the pixel voltage applied to a pixel which should emit light to a value exceeding the driving threshold of the electron-emitters, and to set, as the sum of the scanning signal and the drive signal, the pixel voltage applied to a pixel which should not emit light to a value less than the driving threshold of the electron-emitters; wherein the drive circuit is configured to temporarily increase the pixel voltage of at least the pixel which should not emit light, upon driving of each scanning line.

According to a second aspect of the present invention, there is provided a display driving method for a display panel having a plurality of scanning lines, a plurality of signal lines, and a plurality of pixels located near intersections between the scanning lines and the signal lines and having electron-emitters each of which is connected to a corresponding scanning line and a corresponding signal line, which comprises sequentially driving the scanning lines with a scanning signal; driving the signal lines with drive signals while each of the scanning lines is being driven, the drive signals having pulse widths corresponding to levels of a video signal for one horizontal line and being of opposite voltage polarity to the scanning signal, to set, as the sum of the scanning signal and the drive signal, the pixel voltage applied to a pixel which should emit light to a value exceeding the driving threshold of the electron-emitters, and to set, as the sum of the scanning signal and the drive signal, the pixel voltage applied to a pixel which should not emit light to a value less than the driving threshold of the electron-emitters; and temporarily increasing the pixel voltage of at least the pixel which should not emit light, upon driving of each scanning line.

With the flat-panel display device and the display driving method, the pixel voltage of the pixel which should not emit light is temporarily increased upon driving of each scanning line. This suppresses the effective voltage applied to each of the electron-emitters of pixels which should not emit light as the potential difference between the potential on the scanning line which makes an instant transition with discharge of a pixel which should emit light and the potential on the signal line, thus allowing discharge damage thereof to be relieved. Furthermore, when the pixel voltage is set to a value exceeding the driving threshold of the electron-emitters in its temporary increase, the effect of relieving the discharge damage will become more pronounced.

### BRIEF DESCRIPTION OF THE SEVERAL VIEWS OF THE DRAWING

FIG. 1 schematically shows the circuit configuration of a flat-panel display device according to an embodiment of the present invention.

FIG. 2 is a timing diagram for use in explanation of the pulse width of a PWM drive signal produced in the flat-panel display device shown in FIG. 1.

FIG. 3 is a timing diagram for use in explanation of the PWM drive signal having a pulse width a shown in FIG. 2 and applied to a signal line for the 0th gradation of a video signal.

FIG. 4 is a timing diagram for use in explanation of a modification that increases the voltage of a scanning signal shown in FIG. 2 in order to obtain a pixel voltage exceeding the driving threshold of the electron-emitters.

FIG. 5 is a graph showing a distribution of moving average values of the luminance ratio when the pixel in the plane coordinate position (315, 96) is set as a point of discharge in a conventional display panel.

FIG. 6 is a graph showing a distribution of moving average values of the luminance ratio when the pixel in the plane coordinate position (717, 182) is set as a point of discharge in the conventional display panel.

FIG. 7 is a graph showing a distribution of moving average values of the luminance ratio when the pixel in the plane coordinate position (2997, 339) is set as a point of discharge in the conventional display panel.

FIG. 8 is a graph showing a distribution of moving average values of the luminance ratio when the pixel in the plane coordinate position (2787, 375) is set as a point of discharge in the conventional display panel.

### DETAILED DESCRIPTION OF THE INVENTION

A flat-panel display device according to an embodiment of the present invention will be described hereinafter with reference to the accompanying drawings. This flat-panel display device is a field emission display (FED) device having a resolution of n×m dots.

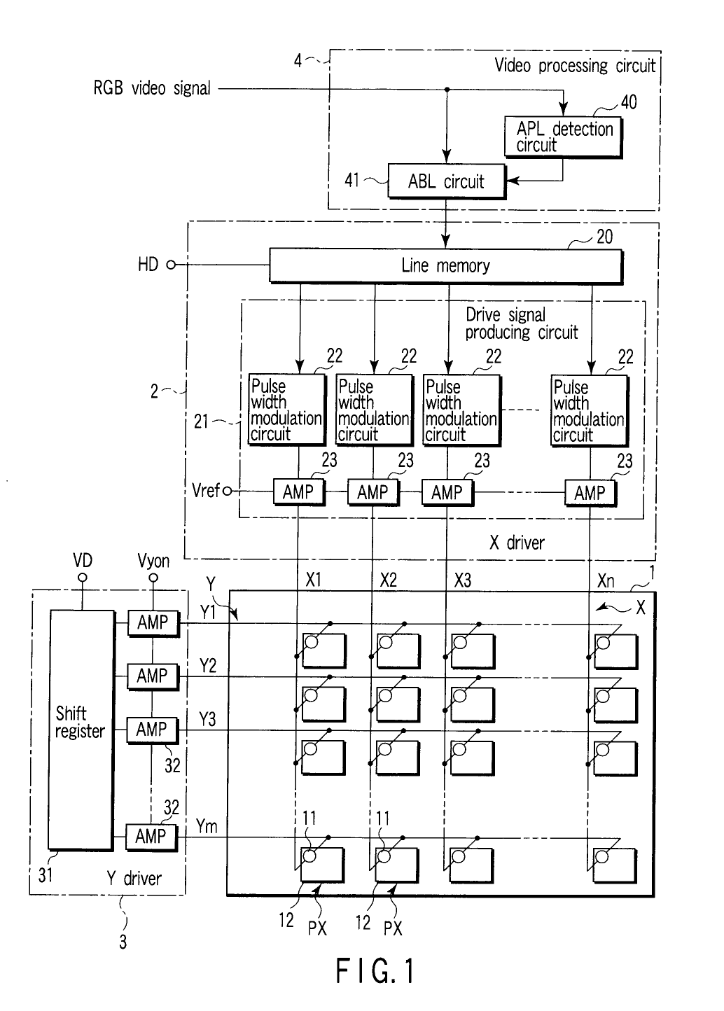

FIG. 1 schematically shows the circuit configuration of the flat-panel display device. This flat-panel display panel has a display panel 1, an X driver 2, a Y driver 3, and a video processing circuit 4. The display panel includes m number of scanning lines Y (Y1-Ym) extending in the lateral (horizontal) direction, n number of signal lines X (X1-Xn) extending in the longitudinal (vertical) direction to intersect the scanning lines Y1-Ym, and m×n number of pixels PX located near intersections between the scanning lines Y1-Ym and the signal lines X1-Xn. Each color pixel unit includes three pixels PX which adjoin in the horizontal direction. In the color pixel unit, the three pixels PX are formed of surface-conduction electron-emitters 11 and phosphors 12 of red (R), green (G) and blue (B) which emit light by electron beams applied from the electron-emitters, respectively. Each of the scanning lines Y is used as a scanning electrode connected to the electron-emitters 11 of the pixels PX on a corresponding horizontal line. Each of the signal lines X is used as a signal electrode connected to the electron-emitters 11 of the pixels PX in a corresponding column.

The X driver 2, the Y driver 3 and the video processing circuit 4 are placed around the display panel 1 as a display drive circuit. The X driver 2 is a signal line driver which is connected one ends of the signal lines X1-Xn. The Y driver 3 is a scanning line driver which is connected to one ends of the scanning lines Y1-Ym. The video processing circuit 4 processes an RGB video signal supplied from an external signal source in digital form. The Y driver 3 sequentially drives the scanning lines Y1-Ym. The X driver 2 drives the signal lines X1-Xn while each of the scanning lines Y1-Ym is being driven by the Y driver 3.

The video processing circuit 4 includes an APL detection circuit 40 which totals levels of the RGB video signal for one frame or the like to detect the average level and an ABL circuit 41 which corrects the RGB video signal on the basis of the average level detected by the APL detection circuit 40 to uniformly lower the luminance for an image pattern which is large in the area of a high-luminance portion. The APL detection circuit 40 may be configured to detect the average gradation level of the RGB video signal for one or more frames or horizontal lines, from discharge current or emission currents actually flowing through the pixels PX.

The X driver 2 includes a line memory 20 which samples and holds levels of the video signal for one horizontal line, which is supplied from the video processing circuit 4 in synchronism with a horizontal sync signal HD, and a drive signal producing circuit 21 which produces n number of PWM drive signals Vx corresponding to levels of the video signal for one frame held in the line memory 20. The drive signal producing circuit 21 includes n number of pulse width modulation circuits 22 each of which produces a pulse signal of a pulse width proportional to the gradation level of the video signal for the corresponding pixel PX, and n number of output buffers 23 each of which outputs a reference voltage Vref from a driving reference voltage terminal as a PWM drive signal Vx to a corresponding one of the signal lines X1-Xn during a period of time equal to the pulse width of the pulse signal from the corresponding pulse width modulation circuit 22. Each of the pulse width modulation circuits 22 is capable of setting pulse widths corresponding to, for example, 1024 gradations from the 0th gradation that is the minimum level of the video signal to the 1023rd gradation that is the maximum level of the input video signals. Here, the scanning signal Vy is set such that Vy=−10.5V and the PWM drive signal Vx is set such that Vx=+8V.

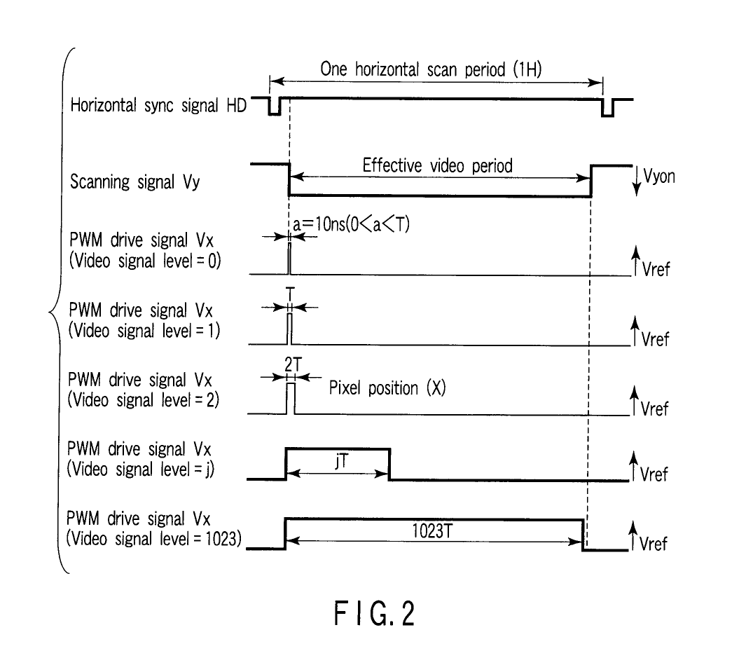

The Y driver 3 includes a shift register 31 which shifts a vertical sync signal VD for each horizontal scan period to output it from one of its m output terminals, and m number of output buffers 32 each of which responds to a pulse output from a corresponding one of the m outputs of the shift register to output a scanning signal Vy to a corresponding one of the scanning lines Y1-Ym in one horizontal scan period (1H). The scanning signal Vy is a voltage Vyon supplied from a scanning voltage terminal and output within one horizontal scan period (1H) as shown in FIG. 2. Each electron-emitter 11 is driven or turned on to provide the electron beam that excites the corresponding phosphor 12 when the sum of the scanning signal Vy (the voltage on the scanning electrode) and the PWM drive signal Vx (the voltage on the signal electrode) exceeds the driving threshold.

As shown in FIG. 2, the pulse width of the PWM drive signal is set to a (here a=10 ns) for the 0th gradation, to T (here T>a) for the 1st gradation, and to j×T for the jth gradation. Here, T is preset to a period equal to, for example, 1/1024 of the effective video period in one horizontal scan period (1H). This prevents the pulse width of the PWM drive signal from exceeding the effective video period even in the 1023rd gradation that is the maximum gradation level of the video signal.

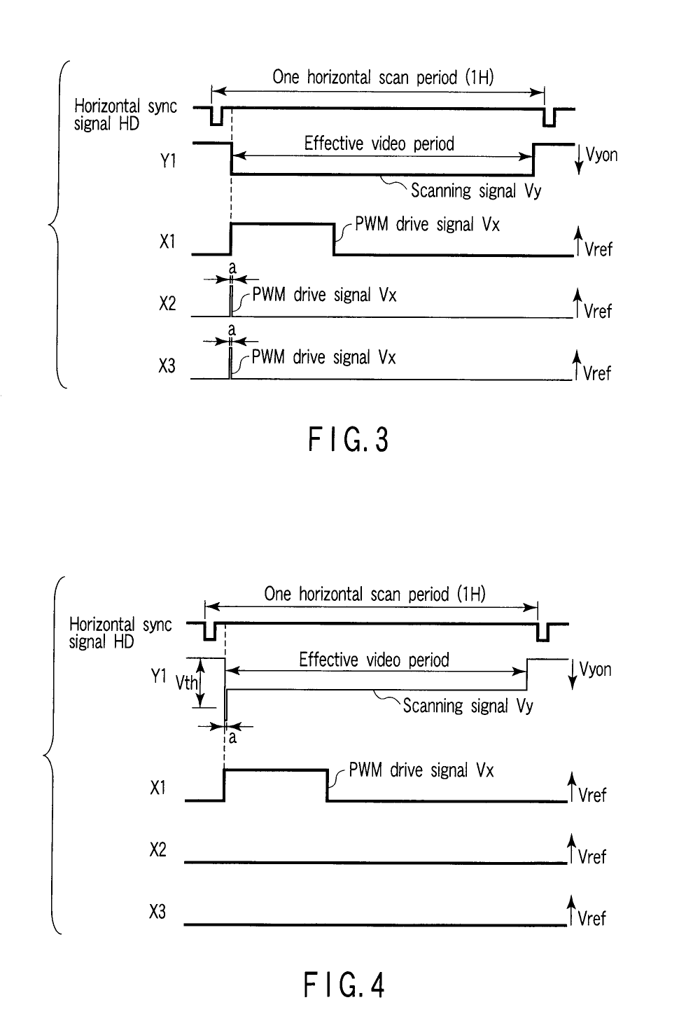

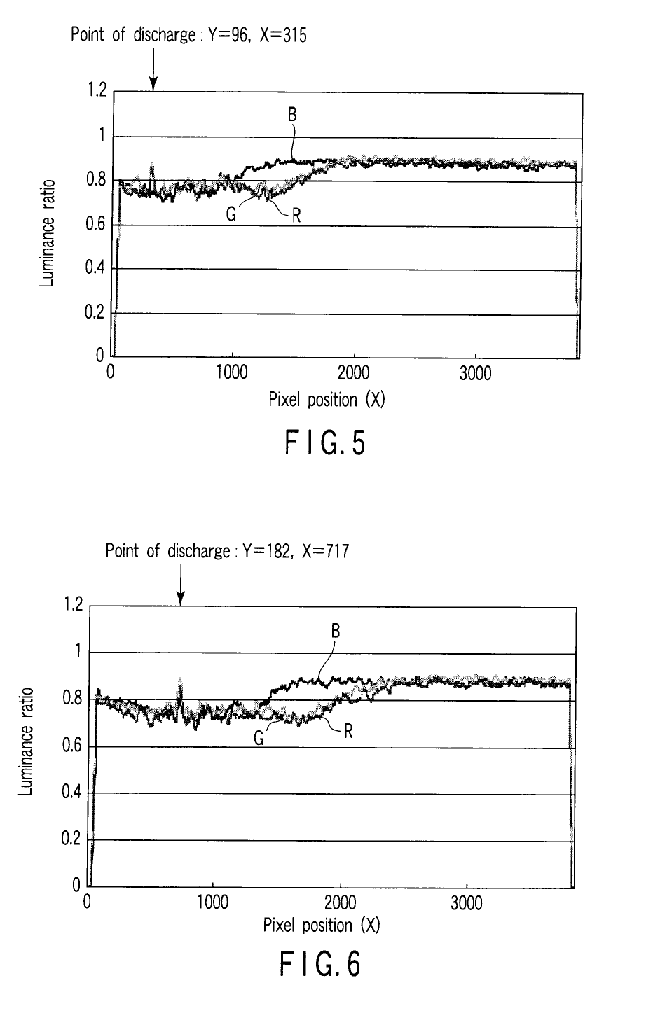

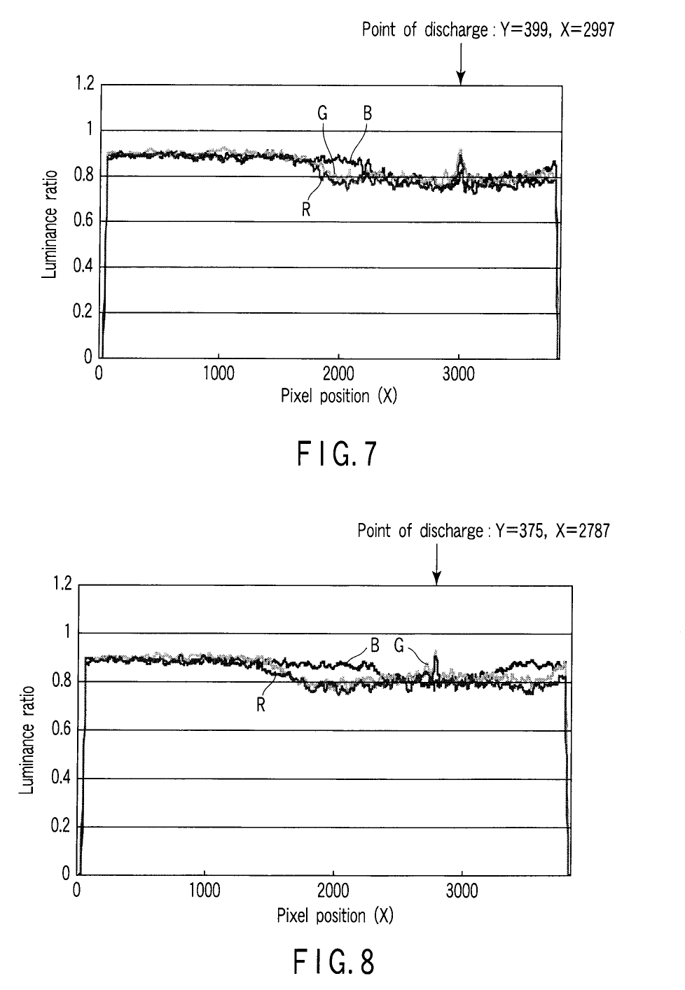

While the Y driver 3 drives the scanning line Y1 with a scanning signal Vy, the X driver 2 drives the signal lines X1, X2, X3, . . . with PWM drive signals Vx having pulse widths corresponding to levels of the video signal for one horizontal line. In the example shown in FIG. 3, the signal line X1 is driven with a PWM drive signal Vx having a pulse width corresponding to the jth gradation. The signal line X2 is driven with a PWM drive signal Vx having a pulse width corresponding to the 0th gradation. The signal line X3 is driven with a PWM drive signal Vx having a pulse width corresponding to the 0th gradation. In this manner, the minimum value of the pulse widths of the PWM drive signals Vx for all the signal lines X1-Xn is set to a value larger than zero. Since emitter discharge tends to occur upon remarkable signal transition, there is a very high probability that it will occur at the rise of the pulse. Therefore, in this driving method, when discharge is carried out in the electron-emitter 11 of a pixel PX which should emit light, a positive voltage (Vx′)is temporarily applied to each of the signal lines X connected to the electron-emitters 11 of other pixels PX which are present on the same scanning line Y as that pixel but should not emit light. In the event that the electron-emitter 11 of a pixel PX which should emit light discharges actually, a transition instantaneously raised to the positive side (ΔVy: about 30V) occurs in the potential on the scanning line Y connected to that electron-emitter 11. Thus, the potential on the scanning line Y immediately after discharge can be expressed as ΔVy−|Vy| (here Vy is −10.5V mentioned above). If there is no positive voltage supplied to the signal lines X allocated for pixels PX which should not emit light, that transition voltage would be applied to their electron-emitters 11. However, in the case where a positive voltage of Vx′ is supplied to these signal lines X, the effective voltage applied to the electron-emitters will become (ΔVy−|Vy|)−Vx′. Thus, the load is relieved by Vx′ and correspondingly the margin for emitter deterioration can be made large. Here, the pulse width corresponding to the 0th gradation is a. The pulse width a is set to a value which satisfies 0<a<T, say, 10 ns. With such a pulse which is extremely short in width, the gradation visibility of each pixel PX will not be impaired.

With the flat-panel display device of this embodiment, all the pixel voltages of the pixels PX on one horizontal line are increased to a value exceeding the driving threshold upon driving of each scanning line Y. That is, of pixels PX on one horizontal line, pixels PX which should not emit light have their electron-emitters supplied with a positive voltage from corresponding signal lines X. This suppresses the effective voltage applied to the electron-emitters 11 of pixels PX which should not emit light as the potential difference between the potential on the corresponding scanning line X which instantaneously transitions as the result of discharge of a pixel PX which should emit light and the potential on the corresponding signal lines X. Thus, the discharge damage can be relieved.

The present invention is not limited to the above embodiment and may be modified in various ways without departing from the scope thereof.

In the above embodiment, the X driver 3 is configured to set the minimum value of the pulse widths of PWM drive signals corresponding to levels of a video signal for one horizontal line to a value larger than zero. Instead, the Y driver 2 may be configured to temporarily increase the voltage of the scanning signal Vy only upon driving of each scanning line Y as shown in FIG. 4. With that voltage of the scanning signal Vy, a pixel voltage exceeding the driving threshold Vth of the electron-emitters 11 is obtainable.

Specifically, the voltage of the scanning signal Vy is increased for a period equal to the above-mentioned pulse width a. In this case, the minimum value of the pulse widths of the PWM drive signals Vx may be set to zero.

Although, in the above-stated embodiment, the X driver 2 is configured to vary the luminance of each pixel PX with the pulse width of a corresponding PWM drive signal, the luminance may be varied according to the pulse width and the voltage amplitude of the PWM drive signal.

Although, in the above-stated embodiment, the scanning signal Vy is a negative voltage and the PWM drive signal Vx is a positive voltage, their voltage polarity may be reversed. That is, the scanning signal Vy and the PWM drive signal Vx may be a positive voltage and a negative voltage, respectively.

The present invention can be applied to a flat-panel display device, such as a field emission display (FED), in which a plurality of pixels are formed using surface-conduction electron-emitters by way of example.

What is claimed is:

1. A flat-panel display device comprising:
a display panel having a plurality of scanning lines, a plurality of signal lines, and a plurality of pixels located near intersections between said scanning lines and said signal lines and having electron-emitters each of which is connected to a corresponding scanning line and a corresponding signal line; and
a drive circuit which sequentially drives said scanning lines with a scanning signal and drives said signal lines by drive signals while each of said scanning lines is being driven, said drive signals having pulse widths corresponding to levels of a video signal for one horizontal line and being of opposite voltage polarity to said scanning signal, to set, as the sum of said scanning signal and said drive signal, the pixel voltage applied to a pixel which should emit light to a value exceeding the driving threshold of said electron-emitters, and to set, as the sum of said scanning signal and said drive signal, the pixel voltage applied to a pixel which should not emit light to a value less than the driving threshold of said electron-emitters;
wherein said drive circuit is configured to temporarily increase the pixel voltage of at least the pixel which should not emit light, upon driving of each scanning line.

2. The flat-panel display device according to claim 1, wherein said drive circuit includes a signal line driver which sets the minimum value of the pulse widths of said drive signals corresponding to the levels of said video signal for one horizontal line to a value larger than zero to temporarily increase the pixel voltage applied to said pixel which should not emit light.

3. The flat-panel display device according to claim 1, wherein said drive circuit includes a scanning line driver which increases the voltage of said scanning signal to temporarily increase the pixel voltage applied to said pixel which should not emit light.

4. The flat-panel display device according to claim 1, wherein the pixel voltage of said pixel which should not emit light is set to a value exceeding the driving threshold of said electron-emitters in the temporary increase.

5. A display driving method for a display panel having a plurality of scanning lines, a plurality of signal lines, and a plurality of pixels located near intersections between said scanning lines and said signal lines and having electron-emitters each of which is connected to a corresponding scanning line and a corresponding signal line, said method comprising:
sequentially driving said scanning lines with a scanning signal;
driving said signal lines with drive signals while each of said scanning lines is being driven, said drive signals having pulse widths corresponding to levels of a video signal for one horizontal line and being of opposite voltage polarity to said scanning signal, to set, as the sum of said scanning signal and said drive signal, the pixel voltage applied to a pixel which should emit light to a value exceeding the driving threshold of said electron-emitters, and to set, as the sum of said scanning signal and said drive signal, the pixel voltage applied to a pixel which should not emit light to a value less than the driving threshold of said electron-emitters; and
temporarily increasing the pixel voltage of at least said pixel which should not emit light, upon driving of each scanning line.

6. The display driving method according to claim 5, which further comprises setting the minimum value of the pulse widths of said drive signals corresponding to the levels of said video signal for one horizontal line to a value larger than zero to temporarily increase the pixel voltage applied to said pixel which should not emit light.

7. The display driving method according to claim 5, which further comprises increasing the voltage of said scanning signal to temporarily increase the pixel voltage applied to said pixel which should not emit light.

8. The display driving method according to claim 5, which further comprises setting the pixel voltage of said pixel which should not emit light to a value exceeding the driving threshold of said electron-emitters in the temporary increase.

9. The flat-panel display device according to claim 2, wherein the pixel voltage of said pixel which should not emit light is set to a value exceeding the driving threshold of said electron-emitters in the temporary increase.

10. The flat-panel display device according to claim 3, wherein the pixel voltage of said pixel which should not emit light is set to a value exceeding the driving threshold of said electron-emitters in the temporary increase.

11. The display driving method according to claim 6, which further comprises setting the pixel voltage of said pixel which should not emit light to a value exceeding the driving threshold of said electron-emitters in the temporary increase.

12. The display driving method according to claim 7, which further comprises setting the pixel voltage of said pixel which should not emit light to a value exceeding the driving threshold of said electron-emitters in the temporary increase.
